(19) United States
(12) Patent Application Publication
(10) Pub. No.: US 2022/0329130 A1
(43) Pub. Date: Oct. 13, 2022

(54) ROTARY MACHINE HAVING AN UNBALANCE DRIVE

(71) Applicant: Mohammed Reza Khodabakhsh, Upland, CA (US)

(72) Inventor: Mohammed Reza Khodabakhsh, Upland, CA (US)

(21) Appl. No.: 17/832,719

(22) Filed: Jun. 6, 2022

(30) Foreign Application Priority Data
Apr. 12, 2021 (DE) 202021101957

(51) Int. Cl. H02K 7/06; H02K 7/18; H02K 7/075

(52) U.S. Cl. CPC H02K 7/061; H02K 7/1892; H02K 7/075

(57) ABSTRACT

A rotary device with an unbalance drive, a carrier unit, which rotates around a first axis of rotation R1, which is rotatably mounted, at least two unbalances (U₁; U₂; . . . Uₓ) of first type, each around a corresponding unbalance axis (UA₁; UA₂; . . . UAₓ) running parallel to the first axis of rotation R1 and at a distance (d_{UA1}; d_{UA2}; . . . d_{UAx}) and are arranged from the first axis of rotation R1 and an unbalance drive device, which is arranged stationary with respect to the carrier unit and at least for driving the unbalances (U₁; U₂; . . . Uₓ) and rotationally coupled with the unbalances (U₁; U₂; . . . Uₓ).

### CROSS-REFERENCE TO RELATED APPLICATION

This application claims benefit of priority to German Patent Application No. 202021101957, filed on Apr. 12, 2021, entitled “Rotationsmaschine aufweisend einen Unwuchtantrieb,” the entire disclosure of which is incorporated by reference herein.

### FIELD OF DISCLOSURE

This application relates to devices used in creating torque by the use of rotational forces.

### BACKGROUND

The invention relates to a rotary machine having an unbalance drive.

It is known that by means of driven unbalances, when arranged on a base plate or are rotatably mounted with respect to a base plate, forces resulting from the imbalance can be transferred to the base plate.

One purpose of the invention is to solve problems current devices are unable to provide. One purpose of the invention is to specify a rotary machine having an unbalance drive in which the unbalance drive acts on a rotor and the rotor can be set in rotation. Another purpose of the invention is to generate a drive torque on the rotor that is as uniform as possible.

Another purpose of the invention is to provide a mechanical decoupling between the unbalance drive and the unit driven by the rotary machine.

### SUMMARY

The present invention overcomes disadvantages of the prior art by providing way of the providing torque more efficiently.

The rotary machine has an unbalance drive, a carrier unit, which rotates around a first axis of rotation R1, which is rotatably mounted, at least two unbalances (U₁; U₂; . . . Uₓ) of first type, each around a corresponding unbalance axis (UA₁; UA₂; . . . UAₓ) running parallel to the first axis of rotation R1 and at a distance (d_{UA1}; d_{UA2}; . . . d_{UAx}) and are arranged from the first axis of rotation R1 and an unbalance drive device, which is arranged stationary with respect to the carrier unit and at least for driving the unbalances (U₁; U₂; . . . Uₓ) and rotationally coupled with the unbalances (U₁; U₂; . . . Uₓ).

With the rotary machine, it is possible to generate a rotary motion of a rotor by driving an unbalance drive, without direct mechanical coupling. This rotary motion is not mechanically rigid, i.e. it is coupled in some way by force and/or friction to a rotary motion of the unbalance drive. This means that mechanical decoupling of the unbalance drive from the driven rotor of the rotary machine is ensured, to the effect that a blockade of the rotor of the rotary machine can take place without mechanical destruction, without the unbalance drive being damaged if it continues to run. In the event of a blockage, for example, the unbalance drive can continue to be driven without mechanical damage occurring.

Furthermore, the unbalances (U₁; U₂; . . . Uₓ) of the first type of the rotary machine can be driven at the same speed by means of the unbalance drive device.

This makes it possible to ensure a particularly simple drive of the unbalances (U₁; U₂; . . . Uₓ) of the first type.

In another embodiment of the invention, the unbalances (U₁; U₂; . . . Uₓ) of the first type can be driven in the same direction.

This results in a particularly high-power transmission and/or torque transmission from the unbalance drive to the rotor of the rotary machine.

In a further preferred embodiment, the unbalances (U₁; U₂; . . . Uₓ) of the first type can be driven synchronized with one another in such a way that unbalance centers of gravity (US₁; US₂; . . . USₓ) simultaneously pass through an outermost and/or innermost position with respect to the first axis of rotation R1 in a radial direction R.

This makes it possible to generate maximum drive torque on the rotor of the rotary machine and still keep overall imbalance of the drive low or even prevent it.

In another preferred embodiment, all unbalances (U₁; U₂; . . . Uₓ) of the first type are arranged and distributed in a circumferential direction U and/or the radial direction R with respect to the carrier unit in such a way that, viewed in a direction R parallel to the axis of rotation R1, a common center of gravity S of all unbalances (U₁; U₂; . . . Uₓ) lies on the axis of rotation R1.

This makes it possible to provide a rotary machine balanced as a complete system.

In particular, all unbalances (U₁; U₂; . . . Uₓ) of the first type execute paths of motion (B_{U1}; B_{U2}, . . . B_{Ux}) which are arranged in planes (E₁; E₂; . . . Eₓ), where the planes (E₁; E₂; . . . Eₓ) lie at least in pairs or all in a common plane E orthogonal to the axis of rotation R1

In this way, dynamic tilting imbalances about axes perpendicular to the axis of rotation R1 can also be kept low or avoided. In particular, moment imbalances can be kept small or prevented.

In another preferred embodiment, unbalances (U_{I}; U_{II}; . . . U_{y}) of the second type are provided, which are in particular phase-shifted to the unbalances (U₁; U₂; . . . Uₓ) of the first type, further preferably in the same direction as these and further in particular relative to each other and/or relative to the unbalances (U₁; U₂; . . . Uₓ) of the first type can be driven at the same speed.

By a phase-shifted arrangement of unbalances (U_{I}; U_{II}; . . . U_{y}) of the second type, it is possible to smooth a torque curve of the rotor of the rotary machine, which occurs due to the unbalances (U₁; U₂; . . . Uₓ) of the first type.

In another preferred embodiment, at least one motor/generator unit is coupled in a rotational driving/drive-able manner at least to the unbalances (U₁; U₂; . . . Uₓ) of the first type.

Through this, a motor or generator smoothing effect of the torque acting on the rotor of the rotary machine can be achieved by selective operation of the motor generator units.

In another preferred embodiment, the unbalances of the second type (U_{I}; U_{II}; . . . U_{y}) are coupled to rotors of the at least one motor/generator unit in a rotationally fixed manner.

This makes it possible to act on both the unbalances (U₁; U₂; . . . Uₓ) of the first type and the unbalances (U_{I}; U_{II}; . . . U_{y}) of the second type with a small number of motor/generator units.

In another embodiment, the unbalances (U_{I}; U_{II}; . . . U_{y}) of the second type perform trajectories of motion (B_{UI}; B_{UII}; . . . B_{uy}) that lie in planes (Eₗ; E_{II}; . . . E_{y}), where the planes (Eₗ; E_{II}; . . . E_{y}) lie at least in pairs or all in a common plane orthogonal to the axis of rotation R1.

This can reduce dynamic tilting moments and resulting imbalances.

In another embodiment, the plane E and the plane E′ are arranged parallel to each other at a distance.

It is considered particularly advantageous that all unbalances (U₁; U₂; . . . Uₓ) of the first kind and all unbalances (U_{I}; U_{II}; . . . U_{y}) of the second type are coupled via a synchronization gear.

This represents a particularly simple way of driving all unbalances.

In a particularly advantageous embodiment, the synchronization gear is a belt transmission or a gear transmission.

Such synchronizing gears exhibit a high degree of efficiency.

Further preferably, a rotor of a first generator is coupled to the carrier unit and a stator of the first generator is coupled to the axis of rotation R1 in a rotationally fixed manner, wherein the rotor of the first generator is coupled in a rotationally fixed manner, the first generator being designed in the manner of an external rotor.

The torque of the rotor can be transmitted to the first generator easily and with high efficiency with this arrangement. A fixed rotor of the generator with respect to the rotor of the rotary machine and a stator of the generator fixed with respect to the stator of the first generator is fixed with respect to the axis of rotation, it is possible to transfer rotational energy of the rotor of the rotary machine to the generator in a simple manner. Such a first generator is then representable in the manner of an external rotor in a particularly simple manner.

In a further preferred embodiment, for driving the synchronous gearbox, the unbalance drive device is coupled to the synchronous gearbox directly or by means of at least one intermediate gearbox, for example a belt intermediate gearbox or a gearwheel intermediate gearbox.

The drive of the synchronous gear via an intermediate gear allows, in an expedient manner, the arrangement of the drive device, i.e. the unbalance drive device with respect to the rotor of the rotary machine to be selected more freely.

In a particularly advantageous embodiment, the phase offset between the unbalances (U₁; U₂; . . . Uₓ) of the first type and the unbalances (U_{I}; U_{II}; . . . U_{y}) of the second kind are 25° to 55°, in particular 35° to 45°, especially preferably 45°.

In such a phase offset, a particularly good smoothing of the torque curve of the rotor of the rotary machine could be observed.

In a further advantageous embodiment, the unbalance drive device is a DC motor, in particular a power supply of the DC motor in the form of, for example, batteries and/or accumulators is connected to the carrier unit so as to be movable therewith.

A compact design is ensured by providing a DC motor as the unbalance drive device and a corresponding power supply on the carrier unit, i.e. one that can move with the rotor of the rotary machine. Of course, it is also possible to supply the unbalance drive device of the rotary machine by means of a non-rotating energy source.

It is particularly advantageous in the sense of the invention that the at least one motor/generator unit is an AC motor/generator unit.

This represents a particularly simple and cost-effective design.

It is considered particularly advantageous that at least one control unit is provided, which controls the at least one motor/generator unit in dependence on a torque amount of the unbalances (U₁; U₂; . . . Uₓ) of a first type and or as a function of a torque contribution of the unbalances (U_{I}; U_{II}; . . . U_{y}) of second kind operates as a motor or as a generator.

Expediently, a control unit is provided which, depending on the periodicity of the torque amount of the unbalances (U₁; U₂; . . . Uₓ) of the first type and as a function of the periodicity of the torque amount of the unbalances (U_{I}; U_{II}; . . . U_{y}) of the second kind, the motor-generator unit can be operated in pairs as a motor or as a generator for the purpose of smoothing or for the purpose of supporting the drive torque.

Further, it is of particular advantage that the carrier unit is coupled to at least one external generator not co-rotating with the carrier unit.

In an advantageous embodiment, the at least one external generator is also operable as a starter motor.

In a further advantageous embodiment, the unbalance weights of at least the unbalances (U₁; U₂; . . . Uₓ) of the first type are variable in size.

In a particularly advantageous way, the torque of the rotor of the rotary machine can be influenced by the size of the unbalanced weights. This allows the torque characteristics to be changed in a simple manner.

In advantageous embodiments, the carrier unit is or substantially forms the rotor of the rotary machine.

This represents a particularly feasible option in terms of construction.

Furthermore, it is preferred that the carrier unit is a stack of a bottom plate, a first bearing plate and a second bearing plate.

Such a sandwich design makes it possible to encapsulate the unbalance drive on the one hand and to accommodate it in a compact and space-saving manner on the other hand. and space-saving manner.

In a further particularly preferred embodiment, the carrier unit is rotatably mounted about a fixed axis, which forms the axis of rotation (R1).

With this measure, it is possible in a particularly simple manner to operate the rotary machine in a fixed gyroscopic manner. A removal of the kinetic energy is easily possible.

It is of particular advantage that the unbalances (U₁; U₂; . . . Uₓ) of the first kind are rotatably mounted between the bearing plates.

Through this, the unbalances (U₁; U₂; . . . Uₓ) of the first kind are well encapsulated in an injury-preventing manner.

In a particularly advantageous embodiment, the unbalances (U_{I}; U_{II}; . . . U_{y}) of the second type rotate in recesses of the base plate, in which in which the motor/generator units are seated.

Through this, the unbalances (U_{I}; U_{II}; . . . U_{y}) of the second kind are well encapsulated in an injury-preventing manner.

Further preferably, the base plate has receiving compartments for, for example, power supply units and/or control units.

Due to the weight added to the rotor of the rotary machine for this purpose, further smoothing effects of the torque curve of the rotary machine can be observed. In addition, such additional weights serve as flywheel mass.

In a particularly preferred embodiment, at least the unbalances (U₁; U₂; . . . Uₓ) of the first type have an unbalance arm and an unbalance armature, wherein fastening devices are provided in the region of the unbalance armature, to which additional unbalance weights can be attached.

In certain embodiments, the carrier unit (2) is coupled to at least one external generator (15; 16) not rotating with the carrier unit (2).

In certain embodiments, the at least one external generator (15; 16) is also operable as a starter motor.

In certain embodiments, the unbalance weights (36) of at least the unbalances (U₁; U₂; . . . Uₓ) of the first type are variable in size.

In certain embodiments, the support unit (2) is or substantially forms a rotor (4) of the rotating machine (1).

In certain embodiments, the carrier unit (2) is a stack of a bottom plate (5), a first bearing plate (6) and a second bearing plate (7).

In certain embodiments, the support unit (2) is rotatably mounted around a fixed axis (3) forming the rotation axis (R1).

In certain embodiments, the unbalances (U₁; U₂; . . . Uₓ) of the first type are rotatably supported between the bearing plates (6; 7).

In certain embodiments, the unbalances (U_{I}; U_{II}; . . . U_{y}) of the second type rotate in recesses of the base plate (5) in which the motor/generator units (24) are seated.

In certain embodiments, the base plate (5) has receiving compartments for, for example, power supply units (21) and/or control units (23).

In certain embodiments, at least the unbalances (U₁; U₂; . . . Uₓ) of the first type have an unbalance arm (32) and an unbalance anchor (33), fastening devices being provided in the region of the unbalance anchor (33), to which unbalance weights (36) can be attached.

### BRIEF DESCRIPTION OF THE DRAWINGS

FIG. 1 is an exploded view of a preferred embodiment of the invention showing a rotor/carrier unit of the rotary machine.

FIG. 2 is a top view of a preferred embodiment of the invention showing a first bearing plate of the carrier unit of the rotary machine with mounted unbalances of the first type.

FIG. 3 is an exploded view of a preferred embodiment of the invention showing an unbalance of the first type.

FIG. 4 is a cross-sectional representation of a preferred embodiment of the invention showing the rotary machine in a schematic representation.

### DETAILED DESCRIPTION

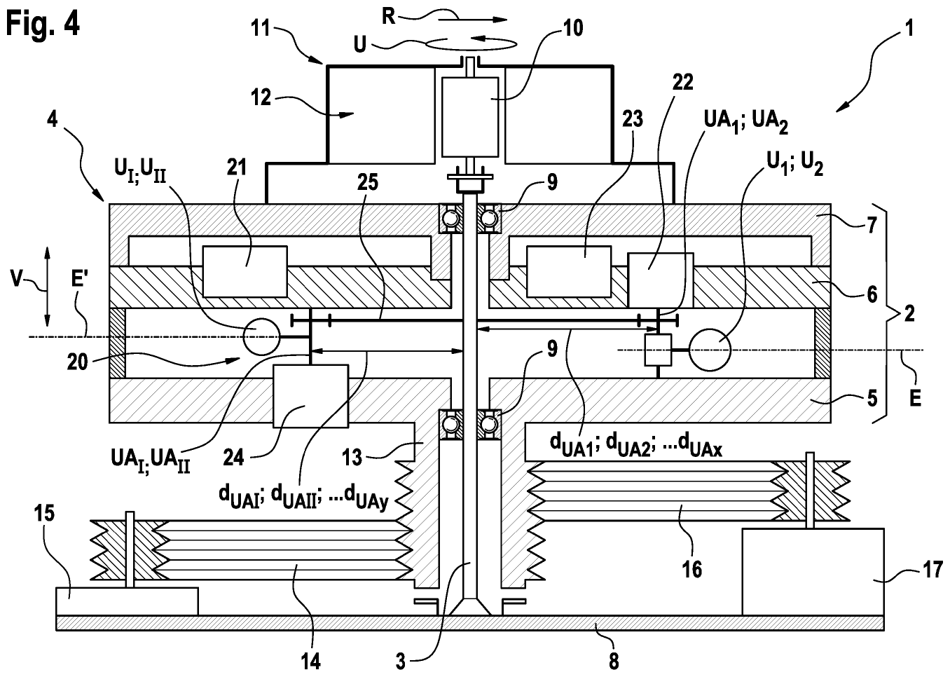

A rotary machine 1 according to the invention is shown in FIG. 4 in highly schematized cross-section. The rotary machine 1 has a carrier unit 2, which is rotatable about a fixed axis 3, which forms a rotation axis R1, in a circumferential direction U.

The carrier unit 2 forms a rotor 4 of the rotary machine 1. The carrier unit 2 is formed, for example, from a base plate 5, a first bearing plate 6 and a second bearing plate 7.

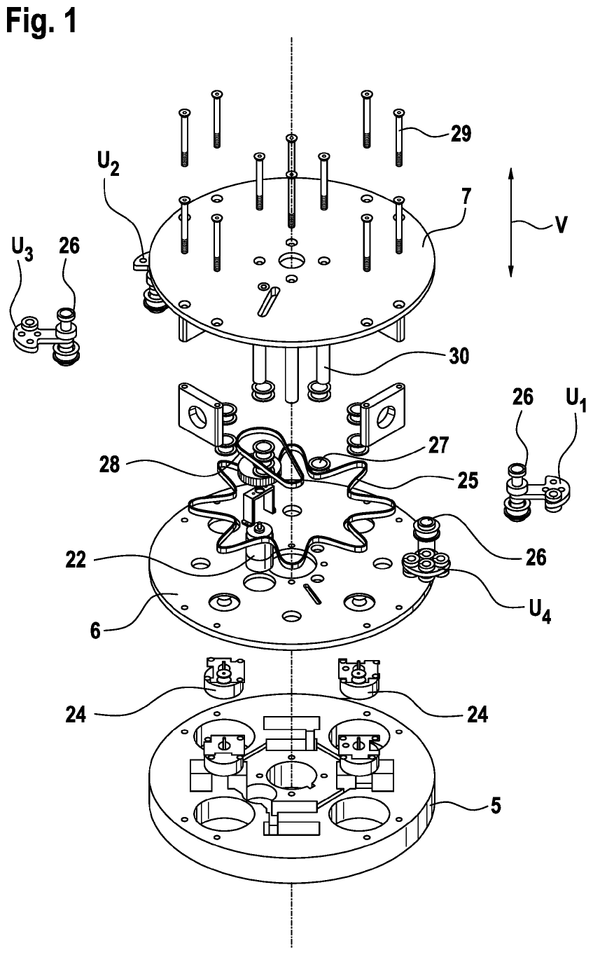

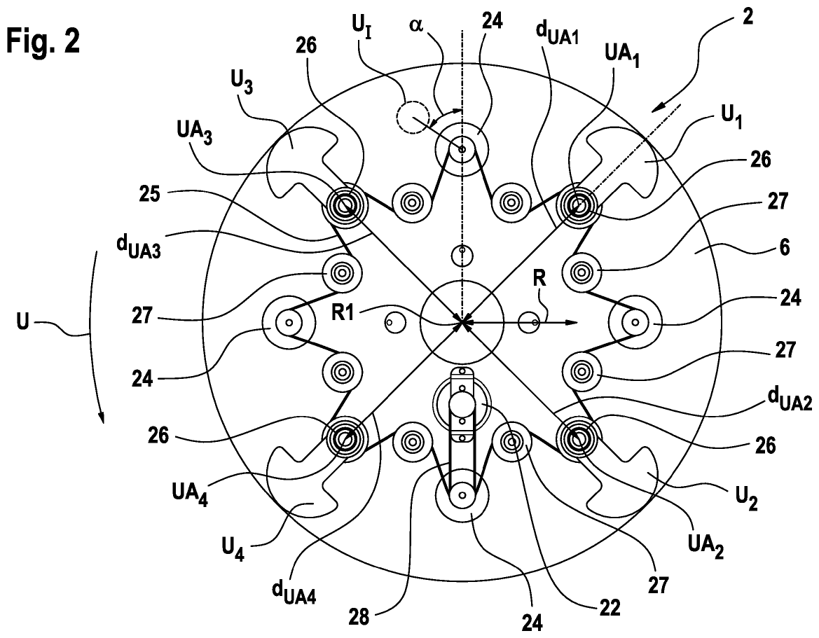

The base plate 5, the first bearing plate 6 and the second bearing plate 7 are described in more detail below with reference to FIG. 1 and FIG. 2.

The fixed axle 3 is, for example, fixedly arranged on a base part 8. The carrier unit 2 is rotatably mounted with respect to the fixed axis 3 by means of bearings 9. At a free end of the fixed axis 3, a stator 10 of a generator 11 is arranged stationary. The generator 11 has an external rotor 12, which rotates on the stator 10, so that the generator 11 is formed as an external rotor generator.

The base plate 5 has a shaft journal 13 extending towards the base part 8, which in the example according to FIG. 4 is coupled to a first external generator 15 via a first belt 14 and to a second external generator 17 via a second belt 16. Thus, a rotation of the rotor 4 or the carrier unit 2 can transmit a rotational motion to the external generators 15 or 17.

At least one of the external generators 15 and/or 17 can also be operated as a motor, and is thus capable of acting as a starter motor for the rotor 4 and/or the carrier unit 2 in a start-up phase of the rotary machine 1.

In the embodiment according to FIG. 4, an unbalance drive 20 is provided, which, viewed in a vertical direction V, is arranged between the base plate 5 and the first bearing plate 6. The unbalance drive 20 has unbalances (U₁; U₂; . . . Uₓ) of a first type and unbalances (U_{I}; U_{II}; . . . U_{y}) of the second kind, which are shown only schematically in the illustration according to FIG. 4.

In detail, this unbalance drive 20 is described in more detail below with reference to FIG. 1 and FIG. 2.

In the example according to FIG. 4, the first bearing plate 6 is provided with energy supply devices 21 for supplying energy to at least one unbalance drive device 22.

The unbalances (U₁; U₂; . . . Uₓ) of the first type are rotatably mounted about unbalance axes (UA₁; UA₂; . . . UAₓ) rotatably mounted. The unbalances (U_{I}; U_{II}; . . . U_{y}) of the second type are mounted about unbalance axes (UA_{I}; UA_{II}; . . . UA_{y}) mounted.

The support unit 2 may further comprise a control unit 23, which is provided for controlling the unbalance drive device 22 and/or at least the motor/generator unit 24 (cf. also FIG. 1). The unbalances (U₁; U₂; . . . Uₓ) of the first type are provided in the embodiment according to FIG. 4 with the unbalance axes (UA_{I}; UA_{II}; . . . UA_{y}), which are at the same time rotor axes of the at least one motor/generator unit 24, and are arranged out of phase with the unbalances (U₁; U₂; . . . Uₓ) of the first type. The unbalances (U₁; U₂; . . . Uₓ) of the first type are in the embodiment according to FIG. 4 with their unbalance axis (UA₁; UA₂; . . . UAₓ) are directly connected to the unbalance drive unit. The unbalances are coupled to each other by a synchronization belt 25, which forms a synchronous gear.

Instead of the synchronizing belt 25 for forming the synchronous gear, a gear train can of course also be arranged.

The rotary machine 1 according to the invention as shown in FIG. 4 has, distributed in the circumferential direction U, a total of four unbalances (U₁; U₂; . . . Uₓ) of the first type, which are arranged uniformly distributed over the circumference.

In the schematic representation according to FIG. 4, however, representative of the unbalances (U₁; U₂; . . . Uₓ) of the first type, only a single unbalance (U₁; U₂; . . . Uₓ) of the first kind is shown.

The unbalances (U₁; U₂; . . . Uₓ) of the first kind are arranged with their unbalance axes (UA₁; UA₂; . . . UAₓ) arranged at a distance (d_{UA1}; d_{UA2}; . . . d_{UAx}) from the rotational axis R1. The unbalances (U₁; U₂; . . . Uₓ) of the first type all lie in a plane E, which in the embodiment example according to FIG. 4 is aligned perpendicular to the axis of rotation R1. The plane E is aligned perpendicular to the drawing plane in the representation according to FIG. 4.

The same applies to the unbalances UI; UII; . . . Uy of the second type. These rotate—as described above—about the unbalance axes (UA_{I}; UA_{II}; . . . UA_{y}), which have a distance (d_{UA1}; d_{UA2}; . . . d_{UAx}) from the axis of rotation R1. The unbalances (U_{I}; U_{II}; . . . U_{y}) of the second type rotate in a plane E′, which is also aligned perpendicular to the axis of rotation R1.

The plane E′ is thus parallel to the plane E and can be arranged at the same level as or offset from the plane E in the vertical direction V.

In the following, the rotary machine 1 according to the invention will be explained in more detail with reference to FIG. 1 and FIG. 2. The embodiment according to FIG. 1 and FIG. 2 differs only insignificantly from the embodiment according to FIG. 4, in particular in that in the rotary machine 1 according to the invention according to FIG. 1 and FIG. 2 the unbalances (U₁; U₂; . . . Uₓ) of the first type, which in the specific case according to FIG. 2 are four unbalances (U₁; U₂; . . . Uₓ) of the first type, are located between the first bearing plate 6 and the second bearing plate 7 and are mounted rotatably with respect to these bearing plates by means of rolling bearings 26 about the corresponding unbalance axes UA₁; UA₂; UA₃; UA₄.

The unbalances (U₁; U₂; . . . Uₓ) of the first kind are arranged uniformly in the circumferential direction U, in particular each offset by 90° at a distance d_{UA1}; d_{UA2}; d_{UA3} and d_{UA4} from the axis of rotation R1. The distances spacing dUA1; dUA2; dUA3 and dUA4 are the same for all unbalances (U₁; U₂; . . . Uₓ) of the first type.

The unbalance drive device 22 is arranged in the radial direction R within the unbalances (U₁; U₂; . . . Uₓ) of the first kind. Between the unbalances (U₁; U₂; . . . Uₓ) of the first kind, a total of four motor/generator units 24 are provided circumferentially and equally spaced. Between each motor/generator unit 24 and an unbalance (U₁; U₂; . . . Uₓ) of the first type, there is a slight inward offset in the circumferential direction radially relative to the unbalances (U₁; U₂; . . . Uₓ) of the first type. A deflection pulley 27 is arranged in each case.

The synchronization belt 25 wraps around all deflection pulleys 27, corresponding belt pulleys of the unbalances (U₁; U₂; . . . Uₓ) of the first type, as well as corresponding belt pulleys of the motor pulleys 27. Kind and corresponding belt pulleys of the motor/generator units 24. The unbalance drive unit 22 is driven by means of a drive belt 28, which functions as an intermediate belt transmission, to a pulley of a motor/generator unit 24 and is thus coupled via the synchronization belt 25 to all deflection pulleys 27, all belt wheels of the motor/generator units 24 and all belt wheels of the unbalances (U₁; U₂; . . . Uₓ) of the first type. Thus, by means of the unbalance drive device 22, the entire unbalance drive 20, which is formed by the unbalances (U₁; U₂; . . . Uₓ) of the first kind and, in particular, also the unbalances U_{I}; U_{II}; U_{III}; U_{IV} of the second kind, which are not shown in FIG. 2, is coupled.

In the embodiment according to FIG. 2, the unbalances U₁; U_{II}; U_{III}; U_{IV} of the second kind are located below the bearing plate 6 and are thus concealed in the representation according to FIG. 2. Only representative for the unbalances U₁; U_{II}; U_{III}; U_{IV} of the second type is an unbalance U_{I} indicated in dashed (concealed) form. The unbalance U_{I} is, for example, phase-shifted by 45° measured with respect to the radial direction R in a certain position of the unbalance drive 20.

To illustrate the arrangement of the components described above in the carrier unit 2, the latter is shown in FIG. 1 rectified in the vertical direction V as an exploded view. FIG. 1 shows almost all components of the carrier unit 2 . For example, the unbalances U_{I}; U_{II}; U_{III}; U_{IV} of the second type are not shown in the illustration according to FIG. 1, however.

The base plate 5, the first bearing plate 6 and the second bearing plate 7 are, for example, connected to one another by means of screws 29 and corresponding spacers 30.

In all other respects, the components as shown in FIG. 1 have already been described in connection with FIG. 2.

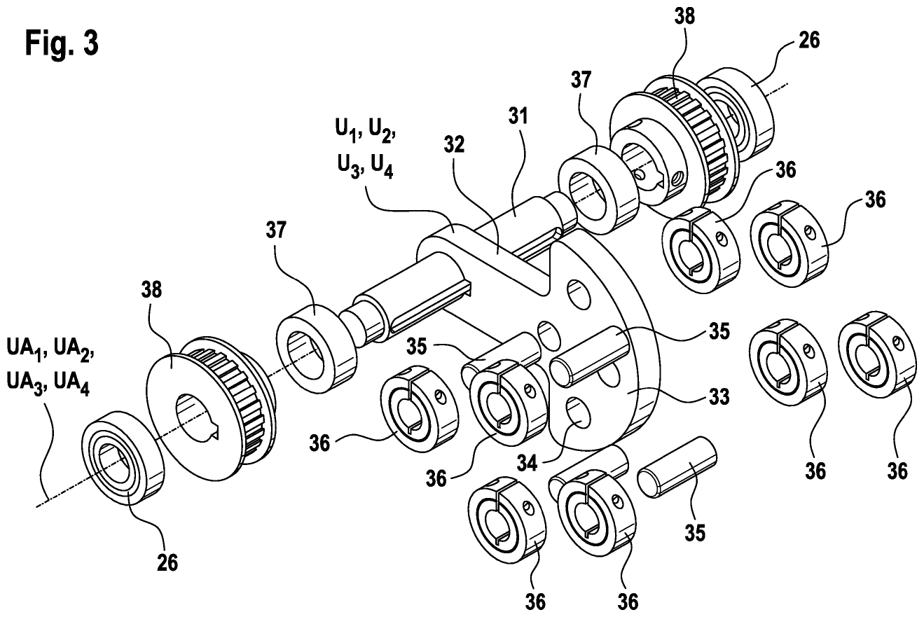

In the following, with reference to FIG. 3, an unbalance (U₁; U₂; . . . Uₓ) of a first type will be explained in more detail by way of example. The unbalance (U₁; U₂; . . . Uₓ) of the first type has an unbalance shaft 31, which can be rotated about the corresponding unbalance axis UA₁; UA₂; UA₃; UA₄. At the end of the unbalance shaft 31 sit the rolling bearings 26, which are mounted in the first bearing plate 6 and in the second bearing plate 7, respectively, as described above in the embodiment according to FIG. 1 and FIG. 2.

The unbalances (U₁; U₂; . . . Uₓ) of the first type each have an unbalance arm 32 and an unbalance anchor 33. The unbalance armature 33 has a plurality of holes 34 through which bolts 35 are insertable. The bolts 35 penetrate the holes 34, whereby unbalance is created at the projecting ends of the bolts 35. ends of the bolts 35 can be attached unbalance weights 36 as required, whereby the resulting unbalanced mass can be increased or decreased.

Spacer rings 37 may also be disposed on the unbalance shaft 31 if structurally convenient.

In the embodiment according to FIG. 3, each shaft end of the unbalance shaft 31 carries a pulley 38, which in the embodiment according to FIG. 3 are designed as toothed belt pulleys.

As an alternative, it may of course be convenient to provide only one pulley 38 if this is sufficient for adequate coupling to the synchronizing belt 25 and no further coupling to belts needs to be made.

### LIST OF NUMERICAL REFERENCES

1—Rotary machine
2—carrier unit
3—Fixed axis
4—Rotor
5—ground plate (base plate)
6—first bearing plate
7—second bearing plate
8—bottom part (base plate)
9—bearings
10—stator
11—generator
12—Outer rotor
13—shaft journal
14—first belt
15—first external generator
16—second belt
17—second external generator
20—Unbalance drive
21—Power supply devices
22—Unbalance drive device/DC motor
23—control unit
24—Motor/generator unit
25—Synchronizing belt
26—Roller bearing
27—Idler pulley
28—Drive belt
29—Screws
30—Spacer
31—Unbalance shaft
32—Unbalance arm
33—Unbalance arm
34—Holes
35—Bolts
36—Unbalance weights
37—Spacer ring
38—Belt pulley
U₁; U₂; . . . Uₓ—Unbalances of the first type
U_{I}; U_{II}; . . . U_{y}—Unbalances of second type
UA₁; UA₂; . . . UAₓ—Unbalance axes
UA_{I}; UA_{II}; . . . UA_{y}—Unbalance axes
d_{UA1}; d_{UA2}; . . . d_{UAx}—Distance
US₁; US₂; . . . USₓ—Unbalance centers of gravity
B_{U1}; B_{U2}, . . . Bᵤₓ—Trajectories
B_{UI}; B_{UII}; . . . B_{uy}—Trajectories
E—Plane
E′—Plane
E₁; E₂, . . . Eₓ—Planes
Eₗ; E_{II}; . . . E_{y}—Planes
R—Radial direction
R1—Axis of rotation
S—center of gravity
U—circumferential direction
V—Vertical direction

What is claimed is:

1. A rotary machine comprising:
an unbalance drive;
a carrier unit, which is mounted rotatably about a first axis of rotation;
a two or more unbalances of a first type, which are each mounted rotatably about a corresponding unbalance axis with respect to the carrier unit and can be moved with the about the first axis of rotation;
wherein the unbalance axes are arranged running parallel to the first axis of rotation at a distance from the first axis of rotation;
an unbalance drive device, which is arranged in a stationary manner with respect to the carrier unit and is coupled to the unbalances at least for the rotational drive of the unbalances.

2. The rotary machine of claim 1, wherein the unbalances of the first type can be driven at the same speed by means of the unbalance drive device.

3. The rotary machine of claim 1, wherein the unbalances of the first type can be driven in the same direction.

4. The rotary machine of claim 2, wherein the unbalances of the first type can be driven in the same direction.

5. The rotary machine of claim 4, wherein the unbalances of the first type can be driven synchronized with one another in such a way that unbalance centers of gravity simultaneously pass through an outermost and/or innermost position with respect to the first axis of rotation in a radial direction.

6. The rotary machine of claim 4, wherein all unbalances of the first type are arranged distributed in a circumferential direction and/or the radial direction with respect to the carrier unit in such a way that, viewed in a direction parallel to the axis of rotation, a common center of gravity of all unbalances lies on the axis of rotation.

7. The rotary machine of claim 4, wherein all unbalances of the first type perform paths of motion lying in planes, said planes lying at least in pairs or all in a common plane orthogonal to the axis of rotation.

8. The rotary machine of claim 4, wherein one or more unbalances of a second type are provided, which are phase-shifted with respect to the unbalances of the first type, further preferably in the same direction as the latter and further in particular with respect to each other and/or relative to the unbalances of the first type can be driven at the same speed.

9. The rotary machine of claim 4, wherein an at least one motor/generator unit is rotationally drivable and coupled to at least one of the unbalances of a first type.

10. The rotary machine of claim 9, wherein the unbalances of the second type are coupled to rotors of the at least one motor/generator unit in a rotationally fixed manner.

11. The rotary machine of claim 8, wherein the unbalances of the second type execute paths of motion which lie in one or more planes, the planes lying at least in pairs or all in a common plane orthogonal to the axis of rotation.

12. The rotary machine of claim 11, wherein a plane (E) and a plane (E′) are arranged spaced apart and parallel to each other.

13. The rotary machine of claim 8, wherein all unbalances of the first type and all unbalances of the second type are coupled via a synchronization gear.

14. The rotary machine of claim 13, wherein the synchronizing gear is a transmission or a belt transmission, or a synchronizing belt or a gear transmission.

15. The rotary machine of claim 4, wherein a rotor of a first generator is coupled in a rotationally fixed manner to the carrier unit and a stator of the first generator, which is coupled in a rotationally fixed manner to the axis of rotation, wherein the first generator is designed in the manner of an external rotor.

16. The rotary machine of claim 13, wherein for driving the synchronization gear, the unbalance drive device is coupled to the synchronization gear directly or by means of at least one intermediate gear.

17. The rotary machine of claim 8, wherein a phase offset between the unbalances of the first type and the unbalances of the second type is 25° to 55°, especially 35° to 45°, particularly preferably 45°.

18. The rotary machine of claim 4, wherein the unbalance drive device is a direct current motor, wherein an energy supply of the direct current motor is in the form of batteries and/or accumulators and connected to the carrier unit in a manner to be movable therewith.

19. The rotary machine of claim 9, wherein the at least one motor/generator unit is of an alternating current type.

20. The rotary machine of claim 9, wherein at least one control unit is provided which operates the at least one motor-generator unit (24) as a motor or as a generator as a function of a torque amount of the unbalances of the first type and/or as a function of a torque contribution of the unbalances of the second type.
